(19) United States
(12) Patent Application Publication
(10) Pub. No.: US 2024/0377820 A1
(43) Pub. Date: Nov. 14, 2024

(54) Method for Detecting and Warning of Operational Failure

(71) Applicant: PETRÓLEO BRASILEIRO S.A. - PETROBRAS, Rio de Janeiro (BR)

(72) Inventors: Bruno Martins Santos, Rio de Janeiro (BR); Vivian Passos De Souza, Rio de Janeiro (BR); Luiz Eduardo Borges Dos Santos, Rio de Janeiro (BR); Adriana De Souza Ferreira, Rio de Janeiro (BR); Rodrigo Rosa Fernandes De Carvalho, Rio de Janeiro (BR); Giovani Santos Correia Da Silva, Rio de Janeiro (BR)

(21) Appl. No.: 18/658,607

(22) Filed: May 8, 2024

(30) Foreign Application Priority Data
May 11, 2023 (BR) 10 2023 009033 8

(51) Int. Cl. G05B 23/02; G06F 17/13

(52) U.S. Cl. CPC G05B 23/0221; G06F 17/13

(57) ABSTRACT

The present invention relates to a method for detecting and warning of operational failures. The methodology was developed for hydrotreatment units and more specifically for monitoring pressure loss in hydrotreatment reactors, but it can be applied to any process that benefits from plant monitoring, especially in cases where the evolution of the undesirable event cannot be mapped by known equations. Adaptations for using in other process plants can be carried out by any specialist in that area, it is only necessary to map the variables that must be observed and define the monitoring needs in terms of acquisition interval, as well as the alarm settings that will depend on the dynamics of the process itself.

### RELATED APPLICATIONS

This application claims the benefit of Brazilian Patent Application Serial No. BR 10 2023 009033 8, filed May 11, 2023, the entire contents of which are expressly incorporated by reference herein.

### FIELD OF THE INVENTION

The present invention falls within the technical field of oil and gas, more specifically related to the monitoring of hydrotreatment units and their reactors and relates to a method for detecting and warning of operational failures.

### BACKGROUND OF THE INVENTION

The quality of fuels has become more restricted over the years and hydrotreatment units have become critical for the operation of refineries. In this context, unscheduled shutdowns of these units have a high cost for refiners and can cause indirect effects throughout the chain and, therefore, something that is sought to be avoided.

Hydrorefining reactions are generally conducted in Trickle-bed type reactors in which the liquid and gas pass in cocurrent mode through a fixed bed of catalysts. Particles from corrosive processes or other contaminants can cause increased pressure loss in these reactors, blocking the passage of load into the catalytic bed.

Considering the operating time of hydroprocessing units, the presence of corrosive products is expected, additionally possible more aggressive operating conditions and/or the type of loads processed.

There are two types of scenarios observed with the increase in pressure loss resulting from bed clogging. The first is when particles accumulate between the catalyst voids in an approximately homogeneous manner, with the growth of pressure loss occurring in a continuous and relatively stable manner, not posing a problem in the short term. The second case is when contaminants are trapped in a relatively narrow layer between different grids.

In this case, the pressure loss grows exponentially and is quite unpredictable, the hydraulic or mechanical limitations of the reactor are reached quickly and there is a need to solve the issue quickly. This limit depends on the fraction of voids in the bed, however the problem becomes critical when the volume of voids is reduced to values between 20 to 25% of the original value, where from that point onwards the stoppage of the unit in the short term would be inevitable.

When this occurs, the possible options for prolonging the stoppage are admitting that the unit will operate with a loss of revenue by reducing the load flow or removing the catalyst layer from the top of the reactor when the problem is concentrated in this region. The solution of using the most appropriate filters and catalyst gradient in loading are known and extensively used, but they do not prevent the problem from occurring.

The work of Perez et al pointed out two options for dealing with the problem after it is already installed. In the first option, the production capacity of a hydrotreatment unit was reduced, allowing it to operate longer but at a financial loss. In this way, changing the operating condition is an artifice to extend the campaign time, but losses are accounted for with the reduction in processing capacity.

The second option is skimming, which consists of stopping the unit and removing the part of the catalyst affected by the pressure loss. This procedure lasts several days and results in financial loss due to the need to stop the unit during this time. Therefore, skimming does not solve the problem and, furthermore, it may be necessary for the procedure to be carried out more than once to prolong the campaign.

Raana et al studied the effect of process parameters such as temperature and pressure on bed clogging and increased pressure loss. The drag of load particles, specifically gas oils derived from Athabasca bitumen, have sand or clay particles that adsorb asphaltenes on their surface.

Particles generally smaller than 20 μm enter the unit along with the load and are not retained by the filters. Even at low concentrations (of the order of 100 to 200 ppm), prolonged exposure and high load flow rates lead to their accumulation, which may lead to increased pressure loss over time.

The authors reported that the increase in bed temperature impacts deposition, either by desorption of asphaltenes that migrate along the bed, or by increasing the formation of coke that interacts with the aluminosilicate fines that cause greater deposition. Furthermore, it was observed that deposition does not only occur physically, but also chemically, but at no point did the study indicate a solution to the problem.

Santos et al developed a methodology for detecting operational failures which, in the case of pressure loss, consists of monitoring the rate of evolution and the moving average of this variable. In this case, the method detects the failure early on and issues an alert so that refiners can act on the problem.

The present invention is an improvement of this methodology, which allows the detection of the failure earlier and more precisely. Therefore, in view of this, and in order to solve the technical problem described above, the present invention proposes the development of a method for detecting and warning of operational failures, predicting them before they even occur.

The methodology was developed for hydrotreatment units and more specifically for monitoring pressure loss in hydrotreatment reactors, but it can be applied to any process that benefits from plant monitoring, especially in cases where the evolution of the undesirable event cannot be mapped by known equations.

### STATE OF THE ART

Document U.S. Ser. No. 10/678,272 B2 is part of the general state of the art and describes methods and system for predicting and early detection of blockage of sliding valves in petrochemical plants or refineries. It is mentioned that a plant or refinery may include equipment such as condensers, regenerators, distillation columns, pumps, slide valves or the like.

Furthermore, it is described that different operating methods can affect the deterioration of the condition of the equipment, thus prolonging its useful life, extending production operating time or providing other benefits.

In its turn, document U.S. Ser. No. 11/194,317 B2 is part of the general state of the art and also protects a method of monitoring a plant, such as a chemical plant or a petrochemical plant or a refinery, and more particularly a method for improving the performance of components that compose operations in a plant.

Document U.S. Pat. No. 9,896,925 B2 is also part of the general state of the art, and describes systems and methods for warning about abnormal drilling conditions. The system and method acquires raw data from drilling equipment that includes at least two drilling-related parameters measured in real time during a drilling operation by a drilling rig and conditions the raw data by removing outliers and/or filtering noise.

And the conditioned data is processed to generate output values and generate an alarm based on the output values to indicate an abnormal drilling condition. Processing the conditioned data includes determining incremental changes in the data values and whether the incremental changes are an increase, decrease, or no change for each of at least two drilling-related parameters.

Documents U.S. Ser. No. 10/678,272 B2, U.S. Ser. No. 11/194,317 B2 and U.S. Pat. No. 9,896,925 B2, despite being in the same technical field, have no direct relationship with the present invention. These documents refer to failures that occur suddenly (slide valve blocking in processes with catalyst fluidization in document U.S. Ser. No. 10/678,272 B2, monitoring of chloride within the appropriate range to avoid corrosive processes in document U.S. Ser. No. 11/194,317 B2 and monitoring of abnormal process conditions in drilling oil wells in document U.S. Pat. No. 9,896,925 B2).

This invention presents a method for monitoring and early detection (prediction) of failures that occur in the long term, under normal process conditions and without a defined cause, which would only be noticeable when they are at an advanced stage and most of the time with no possibility of reversal.

Document U.S. Pat. No. 8,197,248 B2 presents a method for detecting anomalies in autothermal oxidation reactors. Although the present invention and said document apply to reactors, they do not refer to the same type of reactor.

The invention of said document applies to reactors in gaseous flow or solid-liquid suspension, while the present invention applies to porous beds, such as fixed bed reactors, packed towers and similar systems.

As in the previously mentioned documents, the aforementioned document U.S. Pat. No. 8,197,248 B2 relates to the monitoring of known process variables that can cause failures if they operate outside the recommended range, acting in the plant when there is a risk of imminent failure. The present invention refers to the detection of failures that may occur in the long term and without a known or identifiable cause.

Finally, document U.S. Ser. No. 10/913,905 B2 and this invention present similarities in relation to the type of reactor used (fixed bed) and long-term monitoring. However, the deactivation of catalysts mentioned in the aforementioned document is already expected and refineries are already planning to change catalysts accordingly.

Additionally, there are different methods already established for estimating the useful life of the catalyst depending on deactivation. The invention in the aforementioned document uses process variables in its monitoring whose effects on the deactivation of the catalyst are already known, allowing the management of the useful life of the catalyst so that its exchange occurs within the expected time, postponed or even brought forward depending on of the interests of the refiner.

In this way, the invention in U.S. Ser. No. 10/913,905 B2 focuses on plant management and not on detecting unexpected failures. The present invention focuses on a method for monitoring the plant aiming at the early detection of operational problems whose effects are not phenomenologically known (in the present invention the example of pressure loss in fixed bed reactors is used, which does not have known phenomenological equations, while the catalytic deactivation used in said invention in U.S. Ser. No. 10/913,905 B2 is widely represented in the state of the art) and which are only noticeable at an advanced stage.

In view of the above, it is noted that the present invention proposes to present a method for detecting and predicting operational failures even in situations of apparent normality of the plant, where only the use of known process variables and phenomenological equations cannot would allow identification, as in the case of pressure loss exemplified in the present invention, and for events that would not usually cause the unit to stop within the time expected for plant operation.

### BRIEF DESCRIPTION OF THE INVENTION

The present invention relates to a method for detecting and warning of operational failures. The methodology was developed for hydrotreatment units and more specifically for monitoring pressure loss in hydrotreatment reactors, but it can be applied to any process that benefits from plant monitoring, especially in cases where the evolution of the undesirable event cannot be mapped by known equations. Adaptations for use in other process plants can be carried out by any specialist in that area, it is only necessary to map the variables that must be observed and define the monitoring needs in terms of acquisition interval, as well as the alarm settings that will depend on the dynamics of the process itself.

### DETAILED DESCRIPTION OF THE INVENTION

This invention presents a method for detecting and predicting operational failures that was developed for hydrotreatment units and more specifically for monitoring pressure loss in hydrotreatment reactors, but can be applied to any process that benefits from monitoring of the plant in which the evolution of the undesirable event occurs gradually, with long term impact and is not possible to be mapped by known process equations and variables for which the definition of normality varies over time and that the combination of one or more methods to define it is necessary. The method applies to events that would not usually cause the unit to stop during the expected operating time of the plant.

The method developed in the present invention can be used in several types of equipment, such as continuous flow reactors (plug flow reactor), fluidized bed, drip bed reactor, continuous stirred tank reactor (CSTR), vessels that are not reactors but have a porous bed inside and also heat exchangers; more specifically, for monitoring pressure loss in typical systems in the oil chain, such as reactors, heat exchangers and adsorption vessels existing in processes in the areas of exploration and production, refining (such as hydrotreating, hydrocracking, fluid catalytic cracking (FCC), steam reforming, catalytic reforming, among others), petrochemicals and natural gas treatment units.

The method uses the time series ARIMA model to predict the pressure loss (ΔP) of the reactors, using the exogenous variables H₂ consumption (Cons_H₂), DD current flow (F_DD), coke flow (F_GOK), load (F_load), gas (F_GAS) and WABT reaction (WABT). This methodology can be applied to other processes and exogenous variables can be modified to reflect the behavior of other processes.

$$Δ P ( t ) = Δ P ( t - 1 ) + a + b ( 1 ) ⋆ [ Δ P ( t - 1 ) - Δ P ( t - 2 ) ] + b ( 2 ) ⋆ [ Δ P ( t - 2 ) - Δ P ( t - 3 ) ] - e ( t ) - c ( 1 ) ⋆ e ( t - 1 ) + {Cons\_H}_{2} * f\_Cons {\_H}_{2} + F\_DD ⋆ f\_F \_DD + F\_GOK ⋆ f\_F \_GOK + F\_load ⋆ f\_F \_load + F\_GAS ⋆ f\_F \_GAS + WABT ⋆ f\_WABT \qquad Equation ( 1 )$$

where:
ΔP(t) is the pressure loss on the evaluated date
ΔP(t−1) is the pressure loss on the previous day
ΔP(t−2) is the pressure loss two days before
ΔP(t−3) is the pressure loss three days before
a, b(1), b(2) and c(1) are the model parameters
e(t) and e(t−1) are the model residues on the evaluated date and the previous day, respectively
f_Cons_H₂ is the parameter referring to the exogenous variable H₂ consumption
f_F_DD is the parameter referring to the exogenous variable DD current flow
f_F_GOK is the parameter referring to the exogenous variable coke stream flow
f_F_load is the parameter referring to the exogenous variable load flow
f_F_GAS is the parameter referring to the exogenous variable gas flow
f_WABT is the parameter referring to the exogenous variable WABT reaction

The model parameters are estimated with data from the initial days of the plant itself. In this case, data from the first 180 days of the campaign were used, but data from 10 days of the campaign can be used.

Then, the model is used to predict the pressure loss (ΔP) for the remaining days of the campaign. Next, the difference between the pressure loss value (ΔP) predicted by the model and measured by the plant is calculated, according to Equation (2).

$${Dif}_{Δ P} = Δ {P}_{Plant} - Δ {P}_{model} \qquad Equation ( 2 )$$

Monitoring takes place based on the difference calculated in Equation (2), and the behavior of the monitored variable is evaluated using the Shewhart control chart, according to Equations (3) and (4). In the absence of a pressure loss problem, the monitored variable must be within the upper control limit (LSC) defined in Equation (4).

$$MR ( t ) = \vert {Dif}_{Δ P} ( t ) - {Dif}_{Δ P} ( t - 1 ) \vert \qquad Equation ( 3 )$$

where:

MR(t) is the moving range on the evaluated date Dif_{ΔP} (t) and Dif_{ΔP} (t−1) are the difference calculated in Equation (2) on the evaluated date and the previous day, respectively.

$$LSC = 3 \frac{\overline{MR}}{1 , 128} \qquad Equation ( 4 )$$

If the unit presents pressure loss problems, level 1, 2 or 3 alerts are issued, as shown in Equations (5), (6) and (7), respectively.

$$Alert level 1 : If {Dif}_{Δ P} ( t ) > 3 \frac{\overline{MR}}{1 , 128} \qquad Equation ( 5 )$$

$$Alert level 2 : If {Dif}_{Δ P} ( t ) > 16 , 5 \frac{\overline{MR}}{1 , 128} \qquad Equation ( 6 )$$

$$Alert level 3 : If {Dif}_{Δ P} ( t ) > 30 \frac{\overline{MR}}{1 , 128} \qquad Equation ( 7 )$$

Therefore, the method of the present invention generally comprises the following steps:
Step 1—Estimation of the parameters of the time series ARIMA (2,1,1) model shown in Equation (1).
Step 2—Prediction of reactor pressure loss based on Equation (1).
Step 3—Calculate the difference between the pressure loss values predicted by the model and measured in the plant according to Equation (2).
Step 4—Preparation of the control chart according to Equations (3) and (4).
Step 5—Issuance of the alert level according to the following criteria:
   5.1. Level 0: If the value obtained in Equation (2) is lower than the value in Equation (4).
   5.2. Level 1: If the value obtained in Equation (2) is higher than the value in Equation (5) and lower than that in Equation (6).
   5.3. Level 2: If the value obtained in Equation (2) is higher than the value in Equation (6) and lower than that in Equation (7).
   5.4. Level 3: If the value obtained in Equation (2) is higher than the value in Equation (7).

This invention presents several advantages, such as: economic advantages and productivity, in which pressure loss events lead to unscheduled stops and adjustments to non-optimized operating conditions, such as load reduction, so when these problems are avoided or there is the possibility of scheduling the stoppage more in advance results in less economic loss and increased productivity compared to the current case.

Health and safety advantages, providing greater process safety with plant monitoring using this method; reliability, due to the fact that the plant no longer suffers emergency stops, thus increasing its reliability, and environmental, due to the fact that a reduction in the number of unscheduled stops to change the catalyst, reducing the generation of waste arising from this type of procedure.

### Examples of Embodiment

In the examples below, the methodology used to monitor pressure loss monitored daily the difference between the pressure loss value predicted by the model and that measured by the plant. This difference was then assessed using a control chart. The pressure loss problem is identified when the difference between the pressure loss value predicted by the model and that measured by the plant exceeds the limits defined by the control chart.

Example 1: The diesel HDT unit of a refinery A, which

has 5 reactors, operated with pressure loss values between 1.5 and 3.5 kgf/cm² in each reactor and total scheduled operating time of 2200 days. After day 1800, the first two reactors presented pressure loss values above the historical average and a constant upward trend, reaching critical values for the operation of the unit after 1950 days of operation. The methodology detected and flagged the problem with alert level 1 from day 1481 of operation. Alert level 2 was signaled after 1640 days of operation and alert level 3 was issued after 1749 days of operation.

Example 2: The diesel HDT unit of a refinery B, which

has 3 reactors, operated with pressure loss values between 1.0 and 3.0 kgf/cm² in each reactor and total scheduled operating time of 1110 days. After day 750, one of the reactors showed pressure loss values above the historical average and a constant upward trend, reaching critical values for the operation of the unit after 866 days of operation. The methodology detected and flagged the problem for the first time, with alert level 1, after 648 days of operation. Alert level 2 occurred from day 723 of operation and alert level 3 was signaled after 747 days of operation.

Example 3: The diesel HDT unit of a refinery C, which

has 4 reactors, operated with pressure loss values between 1.0 and 3.0 kgf/cm² in each reactor and total scheduled operating time of 2169 days. After day 356, one of the reactors presented pressure loss values above the historical average and a constant upward trend, reaching critical values for the operation of the unit after 576 days of operation. The methodology detected and flagged the problem with alert level 1 after 459 days of operation. Alert level 2 was signaled after 479 days of operation and alert level 3 occurred after 518 days of operation.

Those skilled in the art will value the knowledge presented here and will be able to reproduce the invention in the presented embodiments and in other variants, covered within the scope of the attached claims.

### REFERENCES

Usman et al, Effects of boron addition on the surface structure of Co—Mo/Al₂O₃ catalysts. Journal of Catalysis 247 (2007) 78 to 85.
Y. Saih and K. Segawa, Catalytic activity of CoMo catalysts supported on boron-modified alumina for the hydrodesulphurization of dibenzothiophene and 4,6-dimethyldibenzothiophene. Applied Catalysis A: General 353(2009) 258 to 265.
Perez, M. J. L. et al, Avoiding unplanned reactor shutdowns, In hydroprocessing operations, prevention is better than just dealing with the effects of corrosion and fouling problems, Haldor Topsoe, 2019.
Tsochatzidis, N. A. et al, An investigation of liquid maldistribution in trickle beds. Chemical Engineering Science 57 (2002) 3543 to 3555.
Ranaa, R. et al, Deposition of fine particles of gas oil on hydrotreating catalyst: Impact of process parameters and filtration trends. Fuel Processing Technology 171 (2018) 223 to 231.
Santos et al, Method for detecting operational failures, Brazilian Patent App. Serial No. BR 10 2021 025514 5 (2021).

What is claimed is:

1. A METHOD FOR DETECTING AND WARNING OF OPERATIONAL FAILURES, comprising the steps:
a) Step 1—Estimation of the parameters of the time series ARIMA model shown in the equation
ΔP(t)=ΔP(t−1)+a+b(1)*[ΔP(t−1)−ΔP(t−2)]+b(2)*[ΔP(t−2)−ΔP(t−3)]−e(t)−c(1)*e(t−1)+Cons_H₂*f_Cons_H₂+F_DD*f_F_DD+F_GOK*f_F_GOK+F_load*f_F_load+F_GAS*f_F_GAS+WABT*f_WABT (Equation 1);
b) Step 2—Prediction of reactor pressure loss based on the equation
ΔP(t)=ΔP(t−1)+a+b(1)*[ΔP(t−1)−ΔP(t−2)]+b(2)*[ΔP(t−2)−ΔP(t−3)]−e(t)−c(1)*e(t−1)+0Cons_H₂*f_Cons_H₂+F_DD*f_F_DD+F_GOK*f_F_GOK+F_load*f_F_load+F_GAS*f_F_GAS+WABT*f_WABT (Equation 1);
c) Step 3—Calculate the difference between the pressure loss values predicted by the model and measured in the plant according to the equation
Dif_{ΔP}=ΔPₚₗₐₙₜ−ΔP_{model} (Equation 2);
d) Step 4—Preparation of the control chart according to the equation
MR(t)=|Dif_{ΔP}(t)−Dif_{ΔP}(t−1)| (Equation 3)
and equation
$$LSC = 3 \frac{\overline{MR}}{1 , 128} ; \qquad ( Equation 4 )$$
e) Step 5—Issuance of the alert level according to the following criteria:
Level 0: If the value obtained in Equation (2) is lower than the value in Equation (4); or
Level 1: If the value obtained in Equation (2) is higher than the value in equation
$${Dif}_{Δ P} ( t ) > 3 \frac{\overline{MR}}{1 , 128} \qquad ( Equation 5 )$$
and lower than that in equation
$${Dif}_{Δ P} ( t ) > 16 , 5 \frac{\overline{MR}}{1 , 128} ; \qquad ( Equation 6 )$$
or
Level 2: If the value obtained in Equation (2) is higher than the value in Equation (6) and lower than that in the equation
$${Dif}_{Δ P} ( t ) > 30 \frac{\overline{MR}}{1 , 128} ; \qquad ( Equation 7 )$$
or
Level 3: If the value obtained in Equation (2) is higher than the value in Equation (7).

2. The METHOD according to claim 1, comprising detecting and predicting operational failures in hydrotreatment units.

3. The METHOD according to claim 1, comprising monitoring pressure loss in hydrotreatment reactors in hydrotreatment units.

4. The METHOD according to claim 1, comprising being based on the ARIMA model and using exogenous variables such as H₂ consumption (Cons_H₂), DD current flow (F_DD), coke (F_GOK), load (F_load), gas (F_GAS) and reaction WABT (WABT).

5. The METHOD according to claim 1, wherein the parameters are estimated with data from the initial days of the plant itself, more specifically, data from 10 days onwards can be used.

6. The METHOD according to claim 1, wherein the behavior of the monitored variable is evaluated by the Shewhart control chart or another.

7. The METHOD according to claim 1, wherein if the unit presents pressure loss problems, level 1, 2 or 3 alerts are issued.

8. The METHOD according to claim 1, wherein the reactors are continuous flow type reactors, fluidized bed, drip bed reactors and/or continuous stirred tank reactors.

9. The METHOD according to claim 1, comprising using the exogenous variables most suitable for the system wherein the reactors are continuous flow type reactors, fluidized bed, drip bed reactors and/or continuous stirred tank reactors.
